(19) United States
(12) Patent Application Publication
(10) Pub. No.: US 2011/0080348 A1
(43) Pub. Date: Apr. 7, 2011

(54) ELECTRONIC DEVICES WITH A PRIMARY DISPLAY AND A SELECTIVELY ILLUMINATED SECONDARY DISPLAY

(75) Inventors: Gloria Lin, San Ramon, CA (US); Andrew Hodge, Palo Alto, CA (US); Taido Nakajima, Cupertino, CA (US); Bruno Germansderfer, Boston, MA (US); Saumitro Dasgupta, Boston, MA (US)

(73) Assignee: Apple Inc., Cupertino, CA (US)

(21) Appl. No.: 12/572,222

(22) Filed: Oct. 1, 2009

(51) Int. Cl. G06F 3/041; G09G 5/00

(52) U.S. Cl. 345/173; 345/1.3

(57) ABSTRACT

Systems and methods for selectively illuminating a secondary display are provided. An electronic device can include a primary display (e.g., a liquid crystal display (LCD) screen) and a printed segmented electroluminescence (secondary) display. The primary display can be used to convey visual content to a user, and the secondary display can be used to guide a user providing inputs to the device. For example, the secondary display can be selectively illuminated to provide one or more indicators that represent where or how a user can provide inputs to the device.

### BACKGROUND OF THE INVENTION

This is directed to electronic devices with displays. In particular, this is directed to systems and methods for selectively illuminating a secondary display integrated in an electronic device.

Traditional electronic devices include a display for providing visual outputs to a user. For example, a traditional device may include a liquid crystal display (LCD) for providing visual outputs to a user. Some traditional electronic devices may further include a touch interface overlaying the display for receiving inputs from the user. For example, a device may include a touch screen assembly with a display for providing outputs and a corresponding touch interface for receiving user inputs. To assist a user in providing inputs, traditional devices use the display to provide indicators to the user regarding where and how to provide a touch input. For example, a traditional device may display a virtual button on a touch screen to indicate that a user can touch that portion of the screen to provide an input. However, providing such indicators occupies space on the touch screen that could otherwise be used for displaying visual content.

### SUMMARY OF THE INVENTION

This is directed to systems and methods for selectively illuminating a secondary display. An electronic device can include a primary display (e.g., a liquid crystal display (LCD) screen) and a secondary display (e.g., a printed segmented electroluminescence display). The primary display can be used to convey visual content to a user, and the secondary display can be used to guide a user providing inputs to the device. For example, the secondary display can be selectively illuminated to provide one or more indicators that represent where or how a user can provide inputs to the device.

A secondary display can include multiple regions, and one or more of the regions can include multiple segments. Different regions of the secondary display may be selectively illuminated to draw a user's attention to those regions or an area adjacent to those regions. For example, a region of a secondary display may be illuminated to draw a user's attention to an adjacent area of a touch screen. Different segments of a secondary display region may also be selectively illuminated to form indicators that convey information to a user. For example, a secondary display can selectively illuminate a subset of segments to form an indicator instructing a user to provide a certain type of input.

A secondary display may be selectively illuminated based on a determined condition of the electronic device. For example, a device can include a motion sensing component for determining the angle at which the device is held (e.g., portrait orientation or landscape orientation), and the secondary display can be selectively illuminated based on the determined orientation. A determined condition can include any suitable condition of the device, including its orientation (e.g., portrait or landscape), location, operating state, or active software application.

### BRIEF DESCRIPTION OF THE DRAWINGS

The above and other features of the present invention, its nature and various advantages will be more apparent upon consideration of the following detailed description, taken in conjunction with the accompanying drawings in which:

FIG. 1 is a simplified block diagram of an illustrative electronic device for selectively illuminating a secondary display in accordance with one embodiment of the invention;

FIG. 2 is a schematic view of an illustrative electronic device for selectively illuminating a secondary display in accordance with one embodiment of the invention;

FIGS. 3A-3D are schematic views of an illustrative secondary display region in accordance with one embodiment of the invention;

FIG. 4 is a cross-sectional view of an illustrative electronic device for selectively illuminating a secondary display in accordance with one embodiment of the invention;

FIG. 5 is a cross-sectional view of an illustrative electronic device for selectively illuminating a secondary display in accordance with one embodiment of the invention;

FIG. 6 is a schematic view of an illustrative display for configuring a system to selectively illuminate a secondary display in accordance with one embodiment of the invention; and

FIG. 7 is a flowchart of an illustrative process for selectively illuminating a secondary display in accordance with one embodiment of the invention.

### DETAILED DESCRIPTION

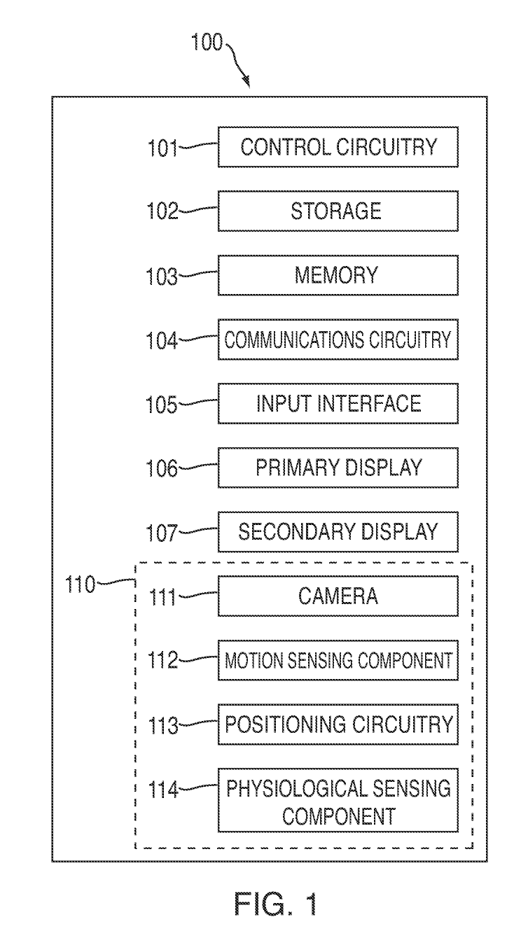

This is directed to systems and methods for selectively illuminating a secondary display in an electronic device. FIG. 1 is a block diagram of an illustrative electronic device for selectively illuminating a secondary display in accordance with one embodiment of the invention. Electronic device 100 can include control circuitry 101, storage 102, memory 103, communications circuitry 104, input interface 105, primary display 106, secondary display 107, and one or more sensors 110. In some embodiments, one or more of the components of electronic device 100 can be combined or omitted. For example, storage 102 and memory 103 can be combined into a single mechanism for storing data. In some embodiments, electronic device 100 can include other components not combined or included in those shown in FIG. 1, such as a power supply (e.g., a battery or kinetics) or a bus. In some embodiments, electronic device 100 can include several instances of the components shown in FIG. 1 but, for the sake of simplicity, only one of each of the components is shown in FIG. 1.

Electronic device 100 can include any suitable type of electronic device operative to play back music. For example, electronic device 100 can include a media player such as an iPod® available from Apple Inc., of Cupertino, Calif., a cellular telephone, a personal e-mail or messaging device (e.g., a Blackberry® or a Sidekick®), an iPhone® available from Apple Inc., pocket-sized personal computers, personal digital assistants (PDAs), a laptop computer, a cyclocomputer, a music recorder, a video recorder, a camera, and any other suitable electronic device. In some cases, electronic device 100 can perform a single function (e.g., a device dedicated to playing music) and in other cases, electronic device 100 can perform multiple functions (e.g., a device that plays music, displays video, stores pictures, and receives and transmits telephone calls).

Control circuitry 101 can include any processing circuitry or processor operative to control the operations and performance of an electronic device of the type of electronic device 100. Storage 102 and memory 103, which can be combined can include, for example, one or more storage mediums or memory used in an electronic device of the type of electronic device 100. In particular, storage 102 and memory 103 can store information related to determining a condition of device 100 such as signals received from a sensor.

Communications circuitry 104 can include any suitable communications circuitry operative to connect to a communications network and to transmit communications (e.g., voice or data) from device 100 to other devices within the communications network. Communications circuitry 104 can be operative to interface with the communications network using any suitable communications protocol such as, for example, Wi-Fi (e.g., a 802.11 protocol), Bluetooth®, radio frequency systems (e.g., 900 MHz, 1.4 GHz, and 5.6 GHz communication systems), cellular networks (e.g., GSM, AMPS, GPRS, CDMA, EV-DO, EDGE, 3GSM, DECT, IS-136/TDMA, iDen, LTE or any other suitable cellular network or protocol), infrared, TCP/IP (e.g., any of the protocols used in each of the TCP/IP layers), HTTP, BitTorrent, FTP, RTP, RTSP, SSH, Voice over IP (VOIP), any other communications protocol, or any combination thereof. In some embodiments, communications circuitry 104 can be operative to provide wired communications paths for electronic device 100.

Input interface 105 can include any suitable mechanism or component for receiving inputs from a user. In some embodiments, input interface 105 can include a touch interface for receiving touch inputs from a user. For example, input interface 105 can include a capacitive touch assembly for receiving touch inputs from a user. In some embodiments, input interface 105 can include a touch interface for receiving touch inputs from a user that include multi-touch gestures. Input interface 105 can also include circuitry operative to convert (and encode/decode, if necessary) analog signals and other signals into digital data, for example in any manner typical of an electronic device of the type of electronic device 100.

Primary display 106 can include any suitable mechanism for displaying visual content. For example, primary display 106 can include a thin-film transistor liquid crystal display (LCD), an organic liquid crystal display (OLCD), a plasma display, a surface-conduction electron-emitter display (SED), organic light-emitting diode display (OLED), or any other suitable type of display. In some embodiments, primary display 106 can include a backlight for illuminating the display. For example, primary display 106 can include one or more incandescent light bulbs, light-emitting diodes (LEDs), electroluminescent panels (ELPs), cold cathode fluorescent lamps (CCFL), hot cathode fluorescent lamps (HCFL), any other suitable light source, or any combination thereof. Primary display 106 can display visual content in black-and-white, color, or a combination of the two. Primary display 106 can display visual content at any suitable brightness level or resolution. In some embodiments, the brightness level or resolution of primary display 106 can be adjusted by a user (e.g., through display configuration options). Primary display 106 can be electrically coupled with control circuitry 101, storage 102, memory 103, any other suitable components within device 100, or any combination thereof. Primary display 106 can display visual content stored in device 100 (e.g., stored in storage or memory in the device) or generated by device 100 (e.g., generated by a processor in the device).

Secondary display 107 may include any suitable display. Secondary display 107 may include a display that is undetectable to the human eye when the display is not illuminated. For example, a user may not be able to see secondary display 107, or any regions or segments of secondary display 107, when the display is not illuminated. In some embodiments, secondary display 107 may include a display incorporating printed segmented electroluminescent (pSEL) technology as made available by Pelikon Limited of Cambridge, United Kingdom. For example, secondary display 107 may include a transparent front electrode formed from indium tin oxide (ITO) coated polyester, phosphor layers, a ceramic dielectric layer, and a segmented display formed from patterned electrodes. In some embodiments, secondary display 107 may include a display incorporating a hybrid electroluminescence and liquid crystal technology such as SmartInk available from Pelikon Limited of Cambridge, United Kingdom. For example, secondary display 107 may include a reflective front layer for visibility in bright environments. In some embodiments, secondary display 107 may include one or more light-emitting diodes (LEDs) for illuminating an array of microperforations in a device's housing. For example, secondary display 107 may include an LED that can selectively illuminate microperforations to create an indicator. Secondary display 107 can be electrically coupled with control circuitry 101, storage 102, memory 103, any other suitable components within device 100, or any combination thereof.

Sensors 110 can include any suitable circuitry or sensor for determining a condition of an electronic device. For example, sensors 110 can include one or more sensors integrated into a device that can monitor one or more conditions of the device. Sensors 110 can include, for example, camera 111, motion sensing component 112, positioning circuitry 113, and physiological sensing component 114. A device can use one or more of sensors 110, or any other suitable sensor or circuitry, to determine a condition of the device and then selectively illuminate a secondary display based at least on the determined condition.

Camera 111 can be operative to detect light. In some embodiments, camera 111 can be operative to detect visible movement in an environment (e.g., the collective movement of a crowd). In some embodiments, camera 111 can be operative to capture digital images. Camera 111 can include any suitable type of sensor for detecting light in an environment. In some embodiments, camera 111 can include a lens and one or more sensors that generate electrical signals. The sensors of camera 111 can be provided on a charge-coupled device (CCD) integrated circuit, for example. Camera 111 can include dedicated image processing circuitry for converting signals from one or more sensors to a digital format. Camera 111 can also include circuitry for pre-processing digital images before they are transmitted to other circuitry within device 100.

Motion sensing component 112 can be operative to detect movements of electronic device 100. In some embodiments, motion sensing component 112 can be operative to detect the angle at which a user is holding device 100 (e.g., vertical/portrait or horizontal/landscape). Motion sensing component 112 can include any suitable type of sensor for detecting the movement of device 100. In some embodiments, motion sensing component 112 can include one or more three-axes acceleration motion sensing components (e.g., an accelerometer) operative to detect linear acceleration in three directions (i.e., the x or left/right direction, the y or up/down direction, and the z or forward/backward direction). As another example, motion sensing component 112 can include one or more two-axis acceleration motion sensing components which can be operative to detect linear acceleration only along each of x or left/right and y or up/down directions (or any other pair of directions). In some embodiments, motion sensing component 112 can include an electrostatic capacitance (capacitance-coupling) accelerometer that is based on silicon micro-machined MEMS (Micro Electro Mechanical Systems) technology, a piezoelectric type accelerometer, a piezoresistance type accelerometer, or any other suitable accelerometer.

Positioning circuitry 113 can be operative to determine the current position of electronic device 100. In some embodiments, positioning circuitry 113 can be operative to update the current position at any suitable rate, including at relatively high rates to provide an estimation of movement (e.g., speed and distance traveled). Positioning circuitry 113 can include any suitable sensor for detecting the position of device 100. In some embodiments, positioning circuitry 113 can include a global positioning system (“GPS”) receiver for accessing a GPS application function call that returns the geographic coordinates (i.e., the geographic location) of the device. The geographic coordinates can be fundamentally, alternatively, or additionally derived from any suitable trilateration or triangulation technique. For example, the device can determine its location using various measurements (e.g., signal-to-noise ratio (“SNR”) or signal strength) of a network signal (e.g., a cellular telephone network signal) associated with the device. For example, a radio frequency (“RF”) triangulation detector or sensor integrated with or connected to the electronic device can determine the approximate location of the device. The device's approximate location can be determined based on various measurements of the device's own network signal, such as: (1) the angle of the signal's approach to or from one or more cellular towers, (2) the amount of time for the signal to reach one or more cellular towers or the user's device, (3) the strength of the signal when it reaches one or more towers or the user's device, or any combination of the aforementioned measurements, for example. Other forms of wireless-assisted GPS (sometimes referred to herein as enhanced GPS or A-GPS) can also be used to determine the current position of electronic device 100. Instead or in addition, positioning circuitry 113 can determine the location of the device based on a wireless network or access point that is in range or a wireless network or access point to which the device is currently connected. For example, because wireless networks have a finite range, a network that is in range of the device can indicate that the device is located in the approximate geographic location of the wireless network.

Physiological sensing component 114 can be operative to detect one or more physiological metrics of a user. In some embodiments, physiological sensing component 114 may be operative to detect one or more physiological metrics of a user operating device 100. For example, physiological sensing component 114 may be operative to detect a physiological metric of a user indicative of how a user is holding device 100 (e.g., the temperature of different areas of the device's housing warmed by the user's hand holding the device). Physiological sensing component 114 can include any suitable sensor for detecting a physiological metric of a user. Physiological sensing component 114 can include a sensor operative to detect a user's heart rate, pulse waveform, breathing rate, blood-oxygen content, galvanic skin response, temperature, heat flux, any other suitable physiological metric, or any combination thereof. For example, physiological sensing component 114 can include a heart rate sensor, a pulse waveform sensor, a respiration sensor, a galvanic skin response sensor, a temperature sensor (e.g., an infrared photodetector), an optical sensor (e.g., a visible or infrared light source and photodetector), any other suitable physiological sensor, or any combination thereof. In some embodiments, physiological sensing component 114 may include one or more electrical contacts for electrically coupling with a user's body. Such sensors can be exposed to the external environment or disposed under an electrically, optically, and/or thermally conductive material so that the contact can obtain physiological signals through the material. A more detailed description of suitable components for detecting physiological metrics with electronic devices can be found in U.S. patent application Ser. No. 11/729,075, entitled “Integrated Sensors for Tracking Performance Metrics” and filed on Mar. 27, 2007, which is incorporated by reference herein in its entirety.

While the embodiment shown in FIG. 1 includes camera 111, motion sensing component 112, positioning circuitry 113, and physiological sensing component 114; it is understood that any other suitable sensor or circuitry can be included in sensors 110. For example, sensors 110 may include a magnetometer or a proximity sensor in some embodiments.

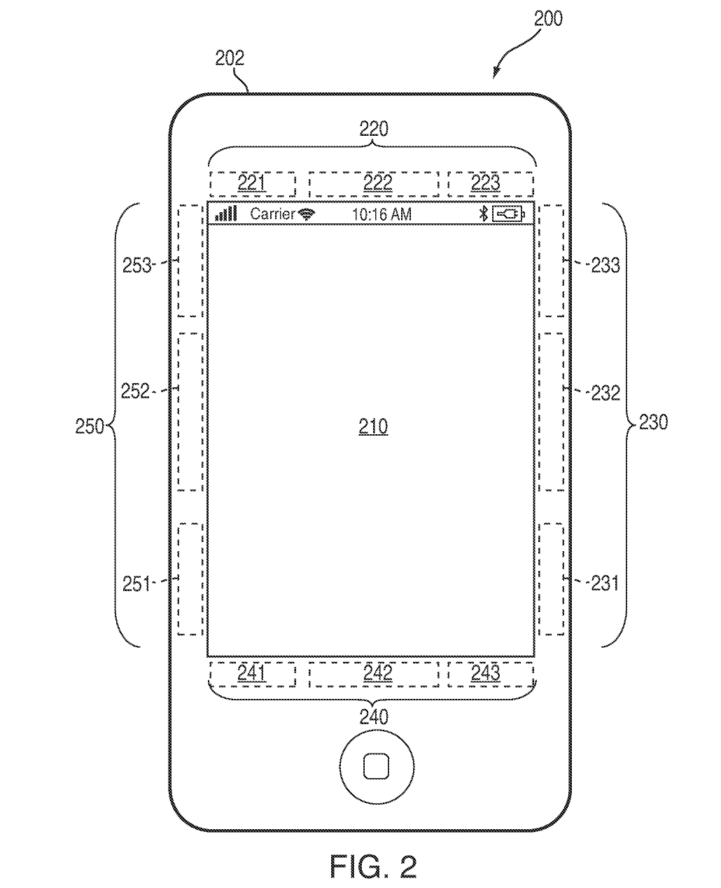

As previously described, a device can selectively illuminate a secondary display based on a determined condition of the device. In some embodiments, the regions of the secondary display that a device illuminates may correspond to the determined condition. For example, if a motion sensing component in a device determines that the device is horizontal, the device may illuminate regions of a secondary display on the left and right peripheries of the display. The illuminated regions of the secondary display can, for example, instruct the user on how to hold the device. In another example, if a device's processor determines that a software application only accepts inputs in a particular area of a touch screen, the device may illuminate one or more regions of a secondary display that correspond to that particular area. The illuminated regions of the secondary display can, for example, instruct the user on where to provide inputs through the touch screen. FIG. 2 is a schematic view of device 200 for selectively illuminating a secondary display in accordance with one embodiment of the invention. Device 200 may include any suitable electronic device with a secondary display (see, e.g., device 100 shown in FIG. 1). Device 200 may include housing 202 and one or more mechanisms, components, or circuitry interior to or embedded in housing 202 (see, e.g., control circuitry 101, storage 102, memory 103, communications circuitry 104, input interface 105, primary display 106, secondary display 107, and one or more sensors 110, all of which are shown in FIG. 1). Housing 202 can include an enclosure formed from one or more components of any suitable material or combination of materials. For example, housing 202 can include a plastic or aluminum back plate and a transparent wall allowing a user to view a primary display and/or a secondary display.

Device 200 can include primary display 210. Primary display 210 can include any suitable mechanism for displaying visual content (see, e.g., primary display 106 shown in FIG. 1). For example, primary display 210 can include an LCD. In some embodiments, primary display 210 can be integrated in a portion of housing 202. For example, primary display 210 can include or be coupled with a transparent wall that forms a front portion of housing 202. Primary display 210 can display visual content stored in device 200 (e.g., stored in storage or memory in the device) or generated by device 200 (e.g., generated by a processor in the device). Primary display 210 can be any suitable shape. For example, primary display 210 may be a rectangular shape (e.g., having a 16:9 aspect ratio). Primary display 210 can include a periphery around the outer portion of the display. The periphery of primary display 210 can form multiple sides of the display. For example, primary display 210 can include a top side, a right side, a bottom side, and a left side. Each side of primary display 210 may be relatively orthogonal to one or more adjacent sides. For example, the top side of primary display 210 may be relatively orthogonal to the left and right sides of the display.

Device 200 can include an input interface for receiving user inputs (see, e.g., input interface 105). For example, device 200 can include a touch interface for use in conjunction with primary display 210. Continuing the example, a touch interface may overlap at least a portion of primary display 210. The combination of primary display 210 and the touch interface can form a touch screen that can both display visual content to a user and receive touch inputs from the user.

Device 200 can include a secondary display. For example, device 200 can include any suitable type of secondary display (see, e.g., secondary display 107 shown in FIG. 1). In some embodiments, a secondary display can be integrated in one or more portions of housing 202. For example, a secondary display can include or be coupled with a transparent wall that forms a front portion of housing 202. In some embodiments, a secondary display can be coupled with a transparent wall that is also included in or coupled with primary display 210. In some embodiments, a secondary display can be integrated in one or more plastic portions of housing 202. For example, housing 202 can include a plastic portion and a transparent wall, and a secondary display can be integrated in the plastic portion at a location adjacent to the periphery of the transparent wall. Device 200 can include a secondary display with multiple regions and each region may be independently illuminated by the display. In some embodiments, device 200 can include a secondary display with regions adjacent to the periphery of primary display 210. For example, device 200 can include a secondary display with regions 221-223, regions 231-233, regions 241-243 and regions 251-253. Each set of regions may form an array of regions along one side of primary display 210. For example, regions 221-223 may form array 220 along the top of primary display 210.

In some embodiments, a device can selectively illuminate one or more regions of a secondary display based on a determined condition of the device. As previously described, determined conditions of a device can include any suitable condition. In some embodiments, a device can selectively illuminate one or more regions of a secondary display based on a determined condition that includes the orientation of the device (e.g., vertical/portrait or horizontal/landscape). For example, when a user is holding device 200 vertically, the device can selectively illuminate one or more regions in array 230 or array 250 to instruct the user to provide touch inputs along the left and/or right sides of primary display 210. Continuing the example, if a user rotates device 200 by 90 degrees so that he or she is holding the device horizontally, any visual content provided through primary display 210 may be rotated a corresponding amount, and device 200 may stop illuminating any regions in array 230 or array 250 and then selectively illuminate one or more regions in array 220 or array 240 to instruct the user to provide touch inputs along the left and/or right sides, based on a horizontal orientation, of primary display 210. In this manner, the secondary display of device 200 can provide indicators on the left and/or right sides of primary display 210 regardless of how a user is holding device 200. In some embodiments, a device can selectively illuminate one or more regions of a secondary display based on a determined condition that includes the software application a device is running. If a device is running a software application that only accepts a certain type of user input, the device can selectively illuminate one or more regions of a secondary display to instruct the user to provide that type of input. For example, if device 200 is running a software application that only accepts touch input in a particular area of a touch screen, device 200 can selectively illuminate one or more of regions 221-223, regions 231-233, regions 241-243 and regions 251-253 to instruct the user to provide touch input in that particular area. As an illustrative example, primary display 210 can be part of a touch screen in device 200 and, if device 200 runs a software application that only accepts touch input in the bottom left corner of the screen, device 200 may illuminate secondary display region 241, secondary display region 251, or both display regions 241 and 251 to instruct a user to provide touch inputs in the bottom left corner of the touch screen. In some embodiments, a device can selectively illuminate one or more regions of a secondary display based on a determined condition that includes the location of the device. For example, when a user is using a device to navigate (e.g., on foot or in a car), the device can determine its location using positioning circuitry (see, e.g., positioning circuitry 113 shown in FIG. 1) and then selectively illuminate one or more secondary display regions to direct the user towards a destination. As an illustrative example, if a user is holding device 200 flat and viewing a map provided through primary display 210, device 200 can selectively illuminate one or more of regions 221-223, regions 231-233, regions 241-243 and regions 251-253 to instruct the user to proceed towards a destination. Continuing the example, device 200 can selectively illuminate one or more display regions in array 250 to direct the user to move forward, turn left, or turn right.

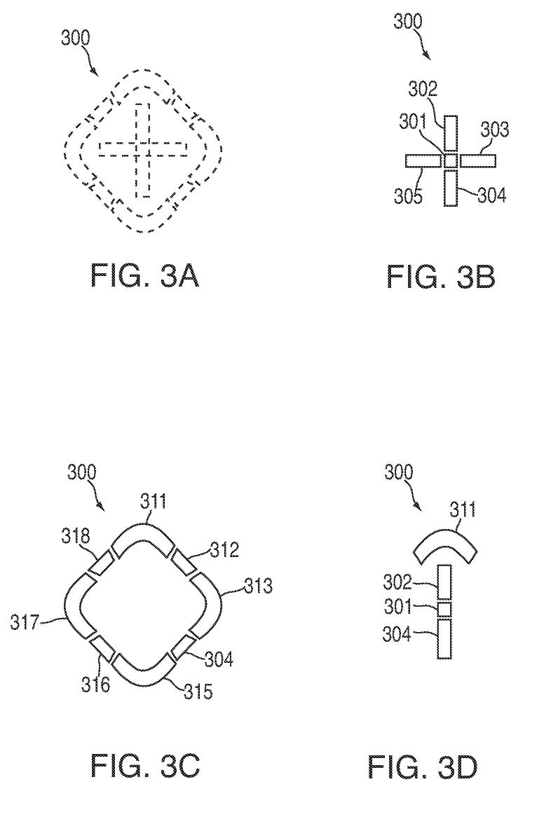

In some embodiments, a region of a secondary display may include segments that can be independently illuminated by the display. For example, a region of a secondary display may include different segments that can be illuminated separately or in combination to provide different indicators. In some embodiments, each different indicator may convey different information to a user. For example, different indicators may represent different types of input that a user can provide. In some embodiments, the region or regions of a secondary display that are illuminated may represent where a user can provide inputs (e.g., a particular section of a touch screen) and the segment or segments of a secondary display region that are illuminated may represent how a user can provide inputs at that location (e.g., a particular type of input that is appropriate). FIGS. 3A-3D are schematic views of an illustrative secondary display region in accordance with one embodiment of the invention. Display region 300 may be part of any suitable secondary display (see, e.g., secondary display 107). Region 300 may be a subset of a larger secondary display (see, e.g., regions 221-223, regions 231-233, regions 241-243 and regions 251-253, all of which are shown in FIG. 2), and the larger display may selectively illuminate region 300 based on a determined condition of the device.

As seen in FIG. 3A, secondary display region 300 can include multiple segments that can be illuminated separately or in combination. For example, each shape defined by a dotted line in FIG. 3A may represent a segment in region 300. Each segment shown in FIG. 3A can be illuminated individually or in combination with other segments. In some embodiments, each segment shown in FIG. 3A may have a shape corresponding to the shape of an electrode (e.g., an electrode on an interior layer of a secondary display), and each segment may be illuminated by creating an electrical potential over the corresponding electrode. For example, each segment may be illuminated by creating an electrical potential between the corresponding electrode and an ITO coated polyester layer. In some embodiments, each segment shown in FIG. 3A may have a shape corresponding to the shape of a screen over an LED, and each segment may be illuminated by activating the LED.

As seen in FIG. 3B, segments in secondary display region 300 can be illuminated to form an indicator in the shape of a cross. For example, segments 301-305 can be illuminated to form a cross-shaped indicator based on a condition of the electronic device. The indicator shown in FIG. 3B can instruct a user to provide inputs corresponding to a directional pad. For example, segments 301-305 may form an indicator that resembles directional pads that are commonly provided on traditional input devices (e.g., video game controllers). Such an indicator may instruct a user to provide, at the location of region 300 or a location adjacent to region 300, a video game input representing spatial direction (e.g., an input moving a character or a cursor).

As seen in FIG. 3C, segments in secondary display region 300 can be illuminated to form an indicator in the shape of a circle. For example, segments 311-318 can be illuminated to form a circle-shaped indicator based on a condition of the electronic device. The indicator shown in FIG. 3C can instruct a user to provide inputs corresponding to a button. For example, segments 311-318 may form an indicator that resembles buttons that are commonly provided on traditional input devices (e.g., video game controllers). Such an indicator may instruct a user to provide, at the location of region 300 or a location adjacent to region 300, a video game input representing an action (e.g., an input triggering a feature or selecting an item).

As seen in FIG. 3D, segments in secondary display region 300 can be illuminated to form an indicator in the shape of an arrow. For example, segments 301, 302, 304, and 311 can be illuminated to form an arrow-shaped indicator based on a condition of the electronic device. The indicator shown in FIG. 3D can instruct a user to provide inputs corresponding to the direction of the arrow. For example, segments 301, 302, 304, and 311 may form an indicator that directs the user's attention to a certain part of a display screen (see, e.g., primary display 106 shown in FIG. 1 and primary display 210 shown in FIG. 2). In another example, segments 301, 302, 304, and 311 may form an indicator that instructs a user to provide, at the location of region 300 or a location adjacent to region 300, an input corresponding to the direction of the arrow.

In accordance with the disclosure, segments of any shape can be selectively illuminated based on a determined condition of the electronic device. Accordingly, the segments and combinations of segments (e.g., indicators) shown in FIGS. 3A-3D are merely illustrative. In some embodiments, different regions of a secondary display may include different segments. For example, a region along a narrow portion of the device's housing (see, e.g., regions 231-233 and regions 251-253) may include one or more long and/or narrow segments.

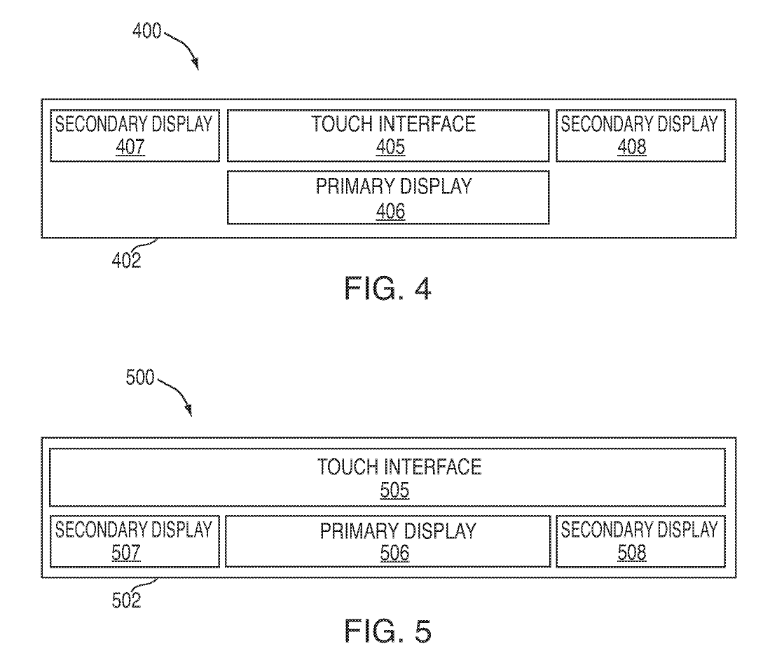

In some embodiments, a device's input interface can include a touch interface. For example, a device's input interface (see, e.g., input interface 105 shown in FIG. 1) can include a touch interface overlapping at least a portion of a primary display (see, e,g., primary display 106 shown in FIG. 1) to form a touch screen. In such an example, the primary display may convey visual content, and the touch interface may receive user inputs. FIG. 4 is a cross-sectional view of device 400 for selectively illuminating a secondary display in accordance with one embodiment of the invention. Device 400 may include any suitable electronic device with a secondary display (see, e.g., device 100 shown in FIG. 1). Device 400 may include housing 402 and one or more mechanisms, components, or circuitry interior to or embedded in housing 402 (see, e.g., control circuitry 101, storage 102, memory 103, communications circuitry 104, input interface 105, primary display 106, secondary display 107, and one or more sensors 110, all of which are shown in FIG. 1). Device 400 may include a touch screen formed by a touch interface overlapping a primary display.

Device 400 can include primary display 406. Primary display 406 can include any suitable mechanism for displaying visual content (see, e.g., primary display 106 shown in FIG. 1 and primary display 210 shown in FIG. 2). In some embodiments, primary display 406 can be integrated in a portion of housing 402. For example, primary display 406 can include or be coupled with a transparent wall that forms a front portion of housing 402.

Device 400 can also include a secondary display (see, e.g., secondary display 107 shown in FIG. 1). In some embodiments, a secondary display can be integrated in a portion of housing 402. For example, a secondary display can be coupled with a transparent wall that forms a front portion of housing 402. In some embodiments, a secondary display can be coupled with a transparent wall that is also included in or coupled with primary display 406. In some embodiments, device 400 can include a secondary display that includes multiple regions (see, e.g., regions 221-223, regions 231-233, regions 241-243 and regions 251-253, all of which are shown in FIG. 2). For example, device 400 can include secondary display region 407 and secondary display region 408. Each of secondary display regions 407 and 408 may include multiple segments (see, e.g., segments 301-305 and 311-318, all of which are shown in FIGS. 3A-3D) that can be illuminated individually or in combination to form indicators. Primary display 406 may include a periphery with multiple sides, and secondary display regions 407 and 408 may each be adjacent to a respective side of the periphery of primary display 406. For example, secondary display region 407 may be adjacent to a left side of primary display 406, and secondary display region 408 may be adjacent to a right side of primary display 406. In some embodiments, secondary display region 407, primary display 406 and secondary display region 408 may each be integrated in a portion of housing 402. For example, secondary display region 407, primary display 406 and secondary display region 408 may be coupled with a transparent wall that forms a portion of housing 402.

Device 400 can further include touch interface 405. Touch interface 405 can be an input interface (see, e.g., input interface 105 shown in FIG. 1) and can include any suitable mechanism for receiving user touch inputs. For example, touch interface 405 can include one or more resistive touch sensors, capacitive touch sensors, infrared touch sensors, surface acoustic wave touch sensors, any other suitable type of touch sensors, or any combination thereof. As seen in FIG. 4, touch interface 405 can overlap primary display 406 but not secondary display regions 407 and 408.

As previously described, secondary displays, including regions within a display and segments within a region (see, e.g., segments 301-305 and 311-318, all of which are shown in FIGS. 3A-3D), can be selectively illuminated based on a determined condition of an electronic device. Accordingly, secondary display regions 407 and 408 or segments within regions 407 and 408 can be selectively illuminated based on a determined condition of device 400 to form indicators. The indicators can instruct a user on where or how to provide touch inputs based on the determined condition of device 400. For example, if device 400 is running a particular software application, indicators provided by secondary display regions 407 or 408 can instruct a user on where and how to provide appropriate inputs to touch interface 405. However, because touch interface 405 does not overlap secondary display region 407 or 408, device 400 may only receive a touch input from a user at a location adjacent to region 407 or 408. For example, a user, upon seeing an indicator provided by secondary display region 407 or 408 may not provide a responsive touch input at a location directly over region 407 or 408.

In some embodiments, a device's input interface can include a touch interface overlapping a primary display and a secondary display. For example, a device's input interface (see, e.g., input interface 105 shown in FIG. 1) can overlap at least a portion of a primary display (see, e.g., primary display 106 shown in FIG. 1 and primary display 210 shown in FIG. 2) and at least a portion of a secondary display (see, e.g., secondary display 107 shown in FIG. 1 and secondary display regions 221-223, regions 231-233, regions 241-243 and regions 251-253, all of which are shown in FIG. 2). In such an embodiment, a user can provide touch inputs at a location directly over the primary display and a location directly over the secondary display. For example, the user can touch a device's housing at a location directly over an indicator formed by a secondary display to provide a touch input to the touch interface. FIG. 5 is a cross-sectional view of device 500 for selectively illuminating a secondary display in accordance with one embodiment of the invention. Device 500 may include any suitable electronic device with a secondary display (see, e.g., device 100 shown in FIG. 1). Device 500 may include housing 502 and one or more mechanisms, components, or circuitry interior to or embedded in housing 502 (see, e.g., control circuitry 101, storage 102, memory 103, communications circuitry 104, input interface 105, primary display 106, secondary display 107, and one or more sensors 110, all of which are shown in FIG. 1). Device 500 may include a touch screen formed by a touch interface overlapping a primary display and a secondary display.

Device 500 can include primary display 506. Primary display 506 can include any suitable mechanism for displaying visual content (see, e.g., primary display 106 shown in FIG. 1 and primary display 210 shown in FIG. 2). Device 500 can also include a secondary display (see, e.g., secondary display 107 shown in FIG. 1). In some embodiments, device 500 can include a secondary display that includes multiple regions (see, e.g., regions 221-223, regions 231-233, regions 241-243 and regions 251-253, all of which are shown in FIG. 2). For example, device 500 can include secondary display region 507 and secondary display region 508. Each of secondary display regions 507 and 508 may include multiple segments (see, e.g., segments 301-305 and 311-318, all of which are shown in FIGS. 3A-3D) that can be illuminated individually or in combination to form indicators. Primary display 506 may include a periphery with multiple sides, and secondary display regions 507 and 508 may each be adjacent to a respective side of the periphery of primary display 506. For example, secondary display region 507 may be adjacent to a left side of primary display 506, and secondary display region 508 may be adjacent to a right side of primary display 506.

Device 500 can further include touch interface 505. Touch interface 505 can be an input interface (see, e.g., input interface 105 shown in FIG. 1) and can include any suitable mechanism for receiving touch inputs from a user. For example, touch interface 505 can include one or more resistive touch sensors, capacitive touch sensors, infrared touch sensors, surface acoustic wave touch sensors, any other suitable type of touch sensors, or any combination thereof. As seen in FIG. 5, touch interface 505 can overlap primary display 506 and secondary display regions 507 and 508. Accordingly, device 500 may receive a touch input from a user at a location directly over region 507 or 508 or a location adjacent to region 507 or 508.

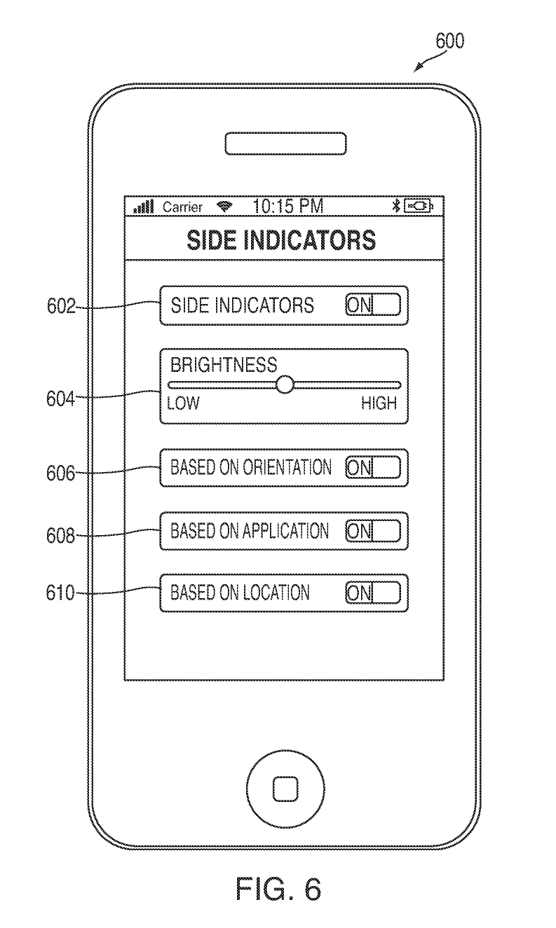

In some embodiments, a user can configure a system to specify how a device selectively illuminates a secondary display. A user may be able to configure any aspect of determining a condition of the device or selectively illuminating a secondary display based on the determined condition. For example, a user may be able to specify which conditions of the device can be the basis for selectively illuminating the secondary display. In another example, a user may be able to specify the regions of a secondary that can be selectively illuminated. FIG. 6 is a schematic view of an illustrative display for configuring a device to selectively illuminate a secondary display in accordance with one embodiment of the invention. Screen 600 can be provided by an electronic device (e.g., device 100 shown in FIG. 1). Screen 600 can be provided through a primary display on an electronic device (e.g., primary display 106 shown in FIG. 1). An electronic device can provide display screen 600 as part of the device's configuration options. In some embodiments, an electronic device can provide screen 600 when a user accesses the configuration options for displays. Screen 600 can include options for selectively illuminating a secondary display based on a determined condition of a device. As seen in FIG. 6, screen 600 can include a title such as “Side Indicators” to represent, in lay terms, the features associated with configuration screen 600. Option 602 can correspond to selectively illuminating a secondary display generally. If option 602 is switched off, the electronic device may not illuminate a secondary display at all. If option 602 is switched on, the electronic device may selectively illuminate a secondary display based on a determined condition of the device. Option 604 can correspond to the brightness at which a secondary display is illuminated. For example, option 604 can be a slider bar with values ranging from low to high, and the value that the slider bar is set to may control the brightness at which a secondary display is illuminated.

Option 606 may correspond to selectively illuminating a secondary display based on the device's orientation (e.g., vertical/portrait or horizontal/landscape). If option 606 is turned off, the electronic device may not selectively illuminate a secondary display based on the device's orientation. If option 606 is turned on, the electronic device may determine the device's orientation (e.g., using one or more motion sensing mechanisms such as motion sensing component 112 shown in FIG. 1) and selectively illuminate a secondary display based on the determined orientation.

Option 608 may correspond to selectively illuminating a secondary display based on the software application running on the device. If option 608 is turned off, the electronic device may not selectively illuminate a secondary display based on the software application running on the device. If option 608 is turned on, the electronic device may determine the software application running on a device and selectively illuminate a secondary display based on the determined application. For example, the device may selectively illuminate a secondary display in response to determining that a software application accepts a particular type of input or inputs in a particular location.

Option 610 may correspond to selectively illuminating a secondary display based on the location of the device. If option 610 is turned off, the electronic device may not selectively illuminate a secondary display based on the device's location. If option 610 is turned on, the electronic device may determine the device's location (e.g., using one or more position sensing mechanisms such as positioning circuitry 113 shown in FIG. 1) and selectively illuminate a secondary display based on the determined location. In some embodiments, determining the device's location may also include determining the heading or orientation of the device (e.g., using a magnetic compass). For example, the device may determine its location, including heading, and then selectively illuminate a region of a secondary display to direct the user in a particular direction.

As shown in FIG. 6, two or more of options 606, 608 and 610 may be turned on at the same time. In such situations, the electronic device may selectively illuminate a secondary display based on multiple determined conditions. For example, the electronic device may selectively illuminate a secondary display based on the device's orientation, an active software application running on the device, and the device's location.

While the embodiment shown in FIG. 6 includes options 606, 608 and 610 corresponding to particular conditions for selectively illuminating a secondary display, it is understood that a secondary display can be selectively illuminated based on any suitable condition or combination of conditions.

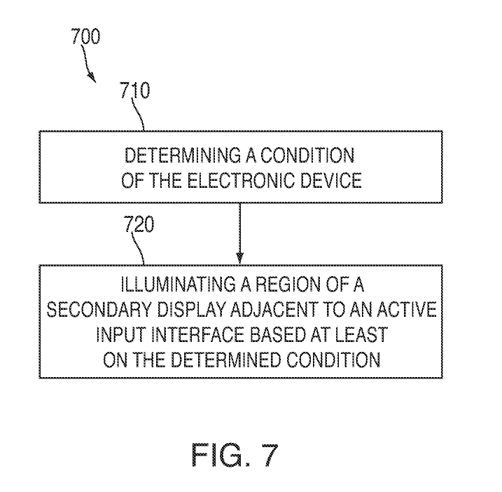

FIG. 7 is a flowchart of illustrative process 700 for selectively illuminating a secondary display in accordance with one embodiment of the invention. Process 700 can be performed by any suitable electronic device (e.g., device 100 shown in FIG. 1, device 200 shown in FIG. 2, device 400 shown in FIG. 4 or device 500 shown in FIG. 5). Process 700 can begin with block 710.

At block 710, a condition of the electronic device can be determined. For example, a device can determine one or more suitable conditions. As previously described, any suitable condition of a device can be determined in accordance with the disclosure. For example, a determined condition can include a device's orientation (e.g., vertical/portrait or horizontal/landscape), location, operating state, active software application, any other suitable condition, or any combination thereof. Moreover, a condition of an electronic device can be determined using any suitable component, mechanism, or circuitry within the device. For example, the device's orientation can be determined using a motion sensing component (see, e.g., motion sensing component 112 shown in FIG. 1), the software application running on a device can be determined using the device's processor (see, e.g., control circuitry 101 shown in FIG. 1), and the location of the device can be determined using positioning circuitry (see, e.g., positioning circuitry 113 shown in FIG. 1).

At block 720, the device can illuminate a region of a secondary display adjacent to both a primary display and an active input interface based at least on the determined condition. For example, a processor in a device (see, e.g., control circuitry 101 shown in FIG. 1) can, in response to obtaining the determined condition, send an activation signal to a secondary display in the device (see, e.g., secondary display 107 shown in FIG. 1) to selectively illuminate the secondary display. A device can selectively illuminate a secondary display based on the determined condition in any suitable manner. In some embodiments, a device can illuminate one or more regions of a secondary display based on the determined condition (see, e.g., regions 221-223, regions 231-233, regions 241-243 and regions 251-253, all of which are shown in FIG. 2). For example, a device may illuminate two or more adjacent regions of a secondary display based on the determined condition (see, e.g., arrays 220, 230, 240 and 250, all of which are shown in FIG. 2). In some embodiments, a device can illuminate one or more segments within one or more secondary display regions based the determined condition (see, e.g., secondary display segments 301-305 and 311-318, all of which are shown in FIGS. 3A-3D). For example, a device may illuminate two or more segments of a secondary display region to form an indicator based on the determined configuration (see, e.g., FIGS. 3A-3D).

The various embodiments of the invention may be implemented by software, but can also be implemented in hardware or a combination of hardware and software. The invention can also be embodied as computer readable code on a computer readable medium. The computer readable medium can be any data storage device that can store data which can thereafter be read by a computer system. Examples of a computer readable medium include read-only memory, random-access memory, CD-ROMs, DVDs, magnetic tape, and optical data storage devices. The computer readable medium can also be distributed over network-coupled computer systems so that the computer readable code is stored and executed in a distributed fashion.

The above described embodiments of the invention are presented for purposes of illustration and not of limitation.

What is claimed is:

1. An electronic device comprising:
a housing;
a processor disposed within the housing;
an input interface electrically coupled with the processor;
a primary display electrically coupled with the processor and having a periphery; and
a secondary display electrically coupled with the processor and disposed around at least a portion of the periphery of the primary display, wherein the processor is operative to:
determine a condition of the electronic device; and
direct the secondary display to illuminate a region adjacent to the input interface based at least on the determined condition.

2. The device of claim 1, wherein the input interface comprises a touch interface.

3. The device of claim 1, wherein the input interface overlaps the primary display.

4. The device of claim 1, wherein the secondary display is undetectable to the human eye when the secondary display is not illuminated.

5. The device of claim 1, wherein the primary display comprises an LCD display operative to display video content.

6. The device of claim 1, wherein the input interface overlaps the secondary display.

7. The device of claim 1, wherein the input interface overlaps both the primary display and the secondary display.

8. The device of claim 1, wherein the secondary display comprises:
a plurality of regions.

9. The device of claim 8, wherein:
the periphery of the secondary display comprises:
a first side; and
a second side orthogonal to the first side; and
the plurality of regions of the secondary display comprises:
a first region disposed adjacent to the first side of the periphery; and
a second region disposed adjacent to the second side of the periphery.

10. The device of claim 9, wherein the processor is further operative to direct the secondary display to illuminate one of the first region and the second region based at least on the determined condition.

11. The device of claim 9, wherein the processor is further operative to:
direct the secondary display to illuminate the first region if the device is in a first orientation; and
direct the secondary display to illuminate the second region if the device is in a second orientation.

12. The device of claim 8, wherein:
at least one of the plurality of regions of the secondary display comprises a plurality of segments; and
the processor is operative to direct the secondary display to illuminate a subset of the plurality of segments to form an indicator based at least on the determined condition.

13. The device of claim 1, further comprising:
a motion sensing component operative to determine a condition of the device that includes an orientation of the device.

14. A method for selectively illuminating a secondary display in an electronic device, the method comprising:
determining a condition of the electronic device; and
illuminating a region of the secondary display adjacent to a primary display and an active input interface based at least on the determined condition.

15. The method of claim 14, wherein determining the condition of the electronic device comprises:
determining an orientation of the electronic device.

16. The method of claim 14, wherein determining the condition of the electronic device comprises:
determining an active area of a touch interface of the electronic device.

17. The method of claim 16, wherein illuminating the region of the secondary display comprises:
illuminating the region of the secondary display adjacent to the active area of the touch interface.

18. The method of claim 14, wherein illuminating the region of the secondary display comprises:
illuminating a subset of a plurality of segments in the region to form an indicator based at least on the determined condition.

19. The method of claim 14, further comprising:
displaying visual content on the primary display before determining the condition, wherein the input interface overlaps at least a portion of the primary display.

20. An electronic device comprising:
a processor;
a primary display electrically coupled with the processor and having a periphery;
a touch interface electrically coupled with the processor and overlapping at least a portion of the primary display; and
a secondary display electrically coupled with the processor and located adjacent to the periphery of the primary display, wherein the processor is operative to:
determine an active area of the touch interface; and
direct the secondary display to illuminate a region adjacent to the active area.

21. The device of claim 20, wherein the secondary display is undetectable to the human eye when the secondary display is not illuminated.

22. The device of claim 20, wherein the secondary display is operative to, in response to a signal from the processor, selectively illuminate the region adjacent to the active area in a manner that instructs the user to provide a touch input at the active area.

23. The device of claim 20, wherein the touch interface also overlaps at least a portion of the secondary display.

24. The device of claim 20, wherein:
the secondary display comprises a plurality of regions;
at least one of the plurality of regions comprises a plurality of segments; and
the processor is operative to direct the secondary display to illuminate a subset of the plurality of segments to form an indicator based at least on the determined condition.

25. The device of claim 24, wherein:
the processor is further operative to determine an appropriate type of input for the active area of the touch interface; and
the indicator formed by the subset of the plurality of segments represents the appropriate type.

26. A computer readable medium for an electronic device, the computer readable medium comprising:
a first instruction code for determining a condition of the electronic device; and
a second instruction code for illuminating a region of the secondary display adjacent to an active input interface based at least on the determined condition.
